(19) United States
(12) Patent Application Publication
(10) Pub. No.: US 2023/0195531 A1
(43) Pub. Date: Jun. 22, 2023

(54) ENERGY-AWARE TASK SCHEDULING

(71) Applicant: Intel Corporation, Santa Clara, CA (US)

(72) Inventors: Maruti GUPTA HYDE, Portland, OR (US); Nageen HIMAYAT, Fremont, CA (US); Ravikumar BALAKRISHNAN, Beaverton, OR (US); Mustafa AKDENIZ, San Jose, CA (US); Marcin SPOCZYNSKI, Leixlip (IE); Arjun ANAND, Santa Clara, CA (US); Marius ARVINTE, Austin, TX (US)

(21) Appl. No.: 17/558,624

(22) Filed: Dec. 22, 2021

(51) Int. Cl. G06F 9/50; G06F 1/3203; G06F 9/48; G06N 3/02

(52) U.S. Cl. CPC G06F 9/5055; G06F 9/5027; G06F 1/3203; G06F 9/4887; G06N 3/02

(57) ABSTRACT

A task modeling system, including a plurality of processing clients having a plurality of processing cores; a task modeler, including a memory storing an artificial neural network; and a processor, configured to receive input data representing a plurality of processing tasks to be completed by the processing client within a predefined time duration; and implement its artificial neural network to determine from the input data an assignment of the processing tasks among the processing cores for completion of the processing tasks within the predefined time duration, and determine a power management factor for each of the plurality of processing cores for power management during the predefined time duration; wherein the artificial neural network is configured to select the power management factor for each of the plurality of processing cores to achieve a power usage within a predefined threshold for the plurality of processing cores during the predefined time duration.

### TECHNICAL FIELD

Various aspects of this disclosure generally relate to distributed learning and task scheduling on multicore platforms.

### BACKGROUND

Energy consumption is a critical driving factor for the operating cost of high-performance computing systems. This problem may be especially pronounced in Fifth Generation Technology Standard (5G) and subsequent generations of base stations, in which workloads are typically executed on high-performance, multicore systems, and in which energy utilization may largely depend on resource scheduling and on the partitioning of cores, memory, and/or cache. For example, a single server within a server rack for Cloud Random Access Network (C-RAN), or a similar system, may service the physical layer baseband processing load from one or more (e.g. up to 16 or potentially more) cells. Depending on the complexity of the 5G configuration or a mixture of 5G/Fourth Generation Technology Standard (4G) configuration and the cell types (e.g. pico cells/small cells/macro cell), there may be an extremely diverse range of workload configurations for the platform.

Furthermore, multiple base stations that are located in the same C-RAN installation may be required to execute similar workflows, but with completely different computational resources available due to a diversity of hardware platforms. Each of these factors represents a challenge for the energy-efficient task distribution within such systems.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary embodiments of the disclosure are described with reference to the following drawings, in which:

FIG. 1 depicts an exemplary block diagram of the task modeling system's global model generation;

FIG. 2 depicts an allocation sampled from the trained model;

FIG. 3 depicts a task modeling system; and

FIG. 4 depicts the artificial neural networks of the task modeling system; and

FIG. 5 depicts a method of task modeling.

### DESCRIPTION

The following detailed description refers to the accompanying drawings that show, by way of illustration, exemplary details and embodiments in which aspects of the present disclosure may be practiced.

The word “exemplary” is used herein to mean “serving as an example, instance, or illustration”. Any embodiment or design described herein as “exemplary” is not necessarily to be construed as preferred or advantageous over other embodiments or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and represent any information as understood in the art.

The terms “processor” or “controller” as, for example, used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a storage element or a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. Memory may be local memory, in which the memory is electrically conductively connected to a processor that reads and/or stores data on the memory. Alternatively or additionally, memory may be remote memory, such as memory which a processor accesses via a communication protocol (e.g. via an internet protocol, a wireless communication protocol, etc.) The remote memory may include a cloud storage. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

The principles and methods disclosed herein permit the coordination of a machine learning model's distributed learning across multiple computing platforms, wherein each of the multiple computing platform continues to use its own local dataset. The model learns to output a solution for latency and dependency-constrained multicore task scheduling, while also taking platform-level energy savings into consideration. The model is trained from aggregated information from multiple platforms. The model is able to generalize to novel platforms without extra training.

Various strategies are available for power management of a processing core. One available power management technique is to change the core's clock speed, which determines the speed at which the core performs calculations. In modern cores, which are generally complementary metal-oxide-semiconductor (CMOS) circuits, current flowing through the core is essentially proportional to the clock speed, since current flows through the core during clock cycles, and almost no current flows through the core between clock cycles. Thus, a reduction of clock cycles results in a reduction of the core's power consumption. This comes at the expense, however, of processing time (e.g. the ability to complete multiple computations quickly). In low latency environments, there may be some room to reduce clock speed for reduced power consumption while still operating within a given time budget; however, further reductions of clock speed may result in processing time that is insufficiently fast to meet the allotted time budget.

Various strategies exist to dynamically alter a core's clock speed. For example, a given core may by manufactured with a plurality of predefined power management settings, each corresponding to a different clock speed. In this manner, the core may be configured to switch between these predefined power management settings for dynamic power management.

Another strategy to reduce core power consumption is to reduce the core's power supply voltage. As an example, the current flowing through a Metal Oxide Semiconductor Field Effect Transistor (MOSFET) is proportional to the gate-source voltage (e.g. the supply voltage) reduced by a threshold voltages. The threshold voltage depends on various physical properties of the MOSFET and cannot be dynamically changed. Thus, the supply voltage is a meaningful factor in the amount of current flowing through a MOSFET and therefore in the core's power consumption.

Various strategies exist to dynamically alter the core's power supply voltage. For example, the core may be configured with a plurality of voltage supply rails, which are configured to provide a plurality of available core supply voltages. The core may have a plurality of predefined power management settings, which may include the ability to change the core's supply voltage for reduction (or increase) of power consumption.

A processor may include one or more power management features to manage a power consumption of the processing client and/or any of its cores. These power management features may include one or more preprogrammed strategies to reduce power consumption, such as by changing the clock speed of the processing client, changing the clock speed of one or more cores of the processing client, changing a supply voltage to one or more cores of the processing client, causing one or more cores of the processing client to enter a standby mode or sleep mode, or any of these. For example, the processor may be configured to dynamically adjust the clock speed and/or supply voltage to be the minimum clock speed and/or supply voltage necessary to satisfy one or more criteria. In some configurations, there may be a predefined number of clock speed and supply voltage combinations, and the processor may be configured to dynamically select one of the predefined combinations.

As part of the power management strategies, the processor may select a clock speed, a supply voltage, a predefined combination of clock speed and supply voltage, or any of these, based on a power management factor. The power management factor may be a factor that that processor may consider in selecting a power management strategy (e.g. in selecting a clock speed, a supply voltage, a predefined combination of clock speed and supply voltage, or any of these). The power management factor may optionally be or include a duration during the processor may instruct a core to enter a sleep more or standby mode (e.g. a number of microseconds for a core to sleep), an instruction to enter a sleep more or a standby mode, an instruction to change the power management strategy, or otherwise.

According to a first aspect of the disclosure, a task modeling system may be configured to receive input data representing a plurality of processing tasks to be completed among a plurality of processing cores and generate from these data an assignment of the processing tasks among the plurality of processing cores for completion of the processing tasks within a predefined time duration. The task modeling system may determine a power management factor for each of the cores to achieve a power usage within a predefined threshold during the predefined time duration. The power usage within the predefined threshold may optionally be a minimum combined power usage.

For a given scenario, a number of cores N associated with a computing platform may have a pool with K tasks to be allocated on the N cores. Each task may belong to a particular task type, which may be characterized by average execution time (under cold/warm cache conditions), latency deadline Tᵢ, a set (potentially empty) of predecessor task types that must be executed before the current task can be started, or any of these. The number of task types may be fewer than the number of tasks, such that the global pool may include multiple tasks of the same task type (e.g., 60 total tasks, distributed among four task types).

Furthermore, the tasks as allocated to the various cores may represent an energy consumption profile E, that, given a set of tasks allocated to a set of cores, expressed by the allocation matrix X, and the execution order P, outputs the consumed energy E(X, P). This function can include several logical conditions for the core to enter one of several idle states, each with their own instantaneous power draw.

For a given E and K (does not appear explicitly, but is implicit in the constraints), it may be desired for a client-side, energy-aware task allocation to find a local model characterized by θ such that it outputs values for X and P that solve the following minimization problem:

$${min}_{X , P} E ( X )$$

s.t. all task deadlines are met

all task dependancies are met

Given a set of training platforms, characterized by the set of functions Eᵢ, i=1, . . . , M and an associated set of scenarios, characterized by the total number of tasks Kᵢ, i=1, . . . , M, a task modeling aggregator generates (e.g. trains) a global model characterized by parameters θ that satisfies (1) a generalization criterion, and (2) a personalization criterion.

Regarding generalization: The generalization criterion concerns whether the global model represents an optimal solution θ for a novel problem (e.g. a set of novel problems, most novel problems, novel problems according to particular constraints, or all novel problems) that is not in the set given by (Eᵢ, Kᵢ). Experiments indicate that training as described herein can yield a model that successfully interpolate to novel scenarios.

Regarding personalization: The personalization criterion relates to whether the global model can receive an input of a novel instance configuration given by (Eₜₑₛₜ,Kₜₑₛₜ) and, from his input, output modified parameters θₜₑₛₜ that can then further be used to output the optimal solution for the corresponding problem instance.

By satisfying either one of generalization or personalization, the task model aggregator ensures that the other is also met, but generalization is a more stringent goal, and may require a larger number of parameters in practice. In contrast, personalization may be achievable with fewer parameters. The principles and methods disclosed herein describe the realization of a distributed learning framework that can learn a generalized model θ but yet allow for platforms to obtain a personalized model θₜₑₛₜ.

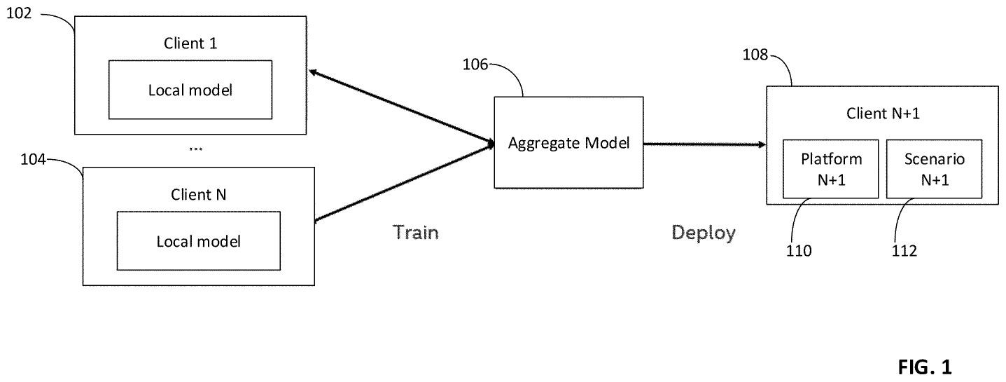

FIG. 1 depicts a block diagram of the task model aggregator's global model generation. During training, a plurality of processing clients (102-104) maintain a set of local models, which they periodically upload to and download from a task model aggregator 106. The processing clients and sever repeat the following training steps for a plurality of training rounds:

In each training round: (1) All processing clients (102-104) update their local models for a number of steps by maximizing the energy saving when their local platforms schedule the local scenarios (experienced by each client). The number of optimization steps may be different for each client, and some processing clients may skip certain rounds (equivalent to zero update steps). (2) Processing clients (102-104) forward the current weights θᵢ to the task model aggregator 106. (3) The task model aggregator 106 aggregates all weights (e.g. by averaging the wrights, or by using any other procedure described herein) to generate θ (an aggregate model 106). (4) Each client (102-104) downloads the new weights θ 106 from the task model aggregator. A “round” or iteration concludes with the completion of step (4). The processing clients (102-104) and the task model aggregator 106 may implement as many rounds as desired. The task modeling system may be configured to perform these steps for a predefined number of iterations or until a predefined stopping criterion is satisfied. This predefined stopping criterion may optionally be a criterion decided by the task model aggregator.

One or more additional processing clients 108 may optionally be configured to utilize this aggregate model 106, such as for task planning and/or power management. The one or more additional processing clients 108 may optionally be heterogeneous to the processing clients 102-104 used to train the model, such that at least one of the one or more additional processing clients 108 include at least one novel platform 110 compared to processing clients 102-104 and/or at least one novel scenario 112 compared to processing clients 102-104. In this manner, one or more additional processing clients 108 may be configured to interpolate a task allocation and/or a power management factor based on the aggregate model. In this manner, the aggregate model may be sufficiently robust as to permit acceptable interpolation from its training data.

In some implementations, the task model aggregator generating the aggregate model 106 may be local to the one or more processing clients 102-104. Alternatively, the task model aggregator generating the aggregate model 106 may be part of the rack of servers for a specific Cloud-RAN installation. Alternatively, the task model aggregator may be located in another location and connected to the processing clients over the network (e.g. over the RAN). Generally speaking, the RAN may be between the mobile client and the base station. Since the models may be run as part of the base station (e.g. over the CU/DU within the O-RAN framework), the processing clients may be connected to the aggregator over the back-haul network. The back haul network may include one or more fiber optic connections, one or more Ethernet connection, fixed wireless technologies for Line-of-sight installations (e.g. exemplarily mmWave technologies such as 60 GHz/5G etc.) or otherwise.

During deployment (e.g. inference), a task model aggregator may store the global model as modified (e.g. trained) in the most-recent iteration. The task model aggregator may optionally send the global model to new processing clients that need to perform task scheduling. Some or all of these new processing clients may have their own platforms, such as platforms that are characterized by one or multiple feature vectors (e.g., the number of cores, the possible power states of each core and their energy consumption, etc.) and that must carry out task scheduling in potentially novel scenarios. Such novel scenarios may optionally include a different number of processing tasks of each type that have to be scheduled for the current scheduling interval (e.g., subframe); novel task types, such as task types characterized by different task characteristics such as multiple task deadlines instead of a single task deadline, different execution times, different arrival pattern of tasks into the task pool (i.e. tasks may arrive at the pool before the currently allocated tasks are all done executing and some of them with deadlines sooner than the already allocated tasks), or each of these. For new processing clients and tasks, processing clients may observe the performance of the model θ by observing the energy consumption and may further fine-tune the model based on local data. Alternately, the global model θ may only be configured to generate intermediate feature maps f_{θ} (Eᵢ,Kᵢ) which can be utilized by new processing clients to extract the feature map based on θ and then fine tune their local unique parameters θ^{local} (and θ as needed) with local training/optimization.

To evaluate the capabilities of this approach in terms of generalizing to novel platform and scenario configurations, data from a total number of five platforms deployed in four scenarios, was centrally aggregated as follows: (a) Platforms having {8, 10, 12, 14 or 16} cores with the same energy consumption characteristics; (b) Scenarios with a total number of {20, 32, 42, 50} tasks to be scheduled, each split among three task types, with the same deadline and a dependency between the first and second tasks (in that order of execution).

Data from each training platform was aggregated, and task scheduling was performed in each training scenario, which led to a total number of 20 training scenario/platform combinations (i.e., 20 processing clients). To evaluate an upper bound of the generalization performance during deployment, training was performed using a single optimization step per round, effectively leading to a centralized and synchronized algorithm. The task scheduling performance on a client with the following characteristics was evaluated: (a) A platform with 9 cores and the same energy consumption characteristics of the training platforms; (b) A scenario with a total number of 37 tasks to be scheduled, belonging to the same three task types and having the same latency deadline and dependencies as the training data.

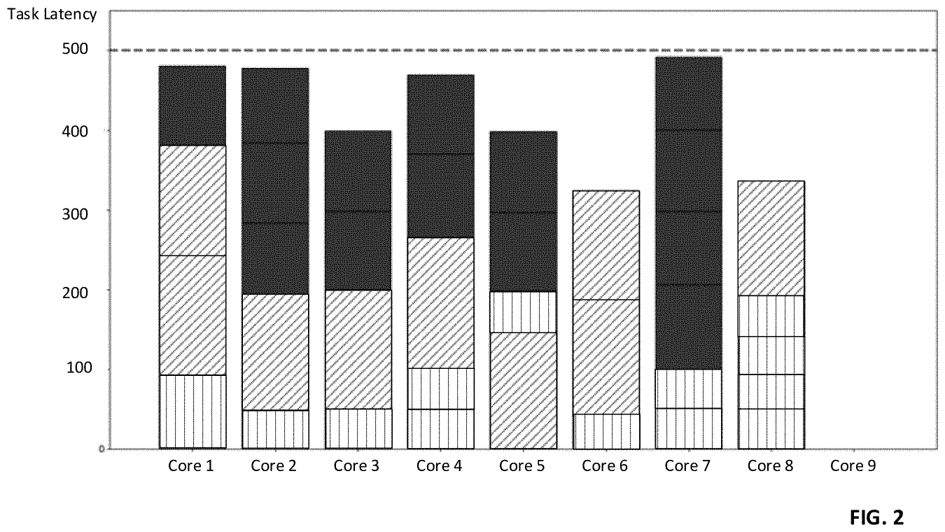

Although some features (such as energy profile of the platform and task types) are shared with the training data, the number of cores and number of tasks are unique compared to the training set. FIG. 2 depicts an allocation sampled from the trained model using a greedy mechanism. For this figure, and as described above, a task model aggregator received individual models from twenty different processing clients. The task model aggregator aggregated the models as described herein, and the twenty processing clients downloaded the aggregate model. The task modeling system (e.g. including the 20 processing clients and the task model aggregator) performed this procedure iteratively, as described herein. The resulting model was then used by a processing client different from the 20 processing clients. In this example, the processing client had 9 cores. Using the aggregate model, the processing client having 9 cores generated a task allocation in when the tasks were distributed to 8 of the 9 cores for completion within 500 μs. In this test, the processing client was able to meet the required latency constraint while ensuring that tasks were performed in a requisite order (e.g. when a first task must be performed before a second task, this requirement is taken into consideration in the task planning). Furthermore, since the tasks could be assigned to 8 cores, core 9 was allowed to be put into sleep mode during this time, thereby achieving a power savings. The results show that the aggregated task model permits task planning and power saving consideration even for novel processing clients. Furthermore, the aggregated task model permits processing clients to perform task planning and power saving considerations by interpolation, wherein they derive from the model a novel result based on data that are different from the training data.

In the examples described above, the artificial neural network used for training of the client models was a Multi-Layer Perceptron (MLP). However, other, and even more complex, types of neural networks may be used for improved online and continuous training purposes. In one example, the artificial neural network may be a recurrent neural network.

Recurrent neural networks are a class of artificial neural networks, wherein the connections between the artificial neural network's nodes form a directed or undirected graph along a temporal sequence. Owing to this configuration, the recurrent neural network may exhibit temporal dynamic behavior. Furthermore, internal state may be used to process variable length sequences of inputs. A person skilled in the art will understand how to implement the principles and methods disclosed herein using a recurrent neural network, and therefore the specifics of recurrent neural network implementation will not be detailed herein.

In another example, the artificial neural network may be a transformer. A transformer is a particular type of deep learning artificial neural network that includes a mechanism that is commonly referred to as self-attention, in which the input data is differentially weighted according to its significance. A person skilled in the art will understand how to implement the principles and methods disclosed herein using a transformer, and therefore the specifics of transformer-implementation will not be detailed herein.

In some configurations, the client platforms may have the same or similar power characteristics. This may be the case, for example, in various base station implementations, in which all hardware may have similar characteristics. In such configurations, the task modeling system may interpolate features from existing models However, in other implementations, the hardware itself may be heterogeneous across different servers within the same rack, and/or with different generations of hardware. This results in differing sets of features than those on which the artificial neural network was trained.

A model that is trained for these heterogeneous systems may require training using data sets for each hardware and/or power management configuration. The resulting model may be quite large. Since the integrative techniques disclosed herein require the individual processing clients to repeatedly download the newly trained model, the large model size may prove to be impractical.

One possible solution to this problem is to employ one or more filtering techniques to pick only a subset of the overall feature list. Using this strategy, however, the resulting global model may not be as applicable for the local processing clients with different specialized feature sets. Thus, local models may then use the global model to solve the task scheduling problem over cores while using a local implementation of the power management unit to apply the local characteristics of the client hardware instead. In so doing, the problem may be broken down to solve the overall task scheduling problem for a given number of cores using a global model, while using use a local power management control algorithm to further train the model to obtain an energy-efficient implementation for the local platform.

The principles and methods disclosed herein may be applicable to a variety of hardware implementations. According to one aspect, they may be applicable to a virtualized, cloud enabled Radio Access Network. Alternatively, they may apply to other platforms, including, but not limited to an enterprise implementation for an automated factory, a data center, or an edge network. The principles and methods disclosed herein may be applicable wherever energy-aware and latency-aware scheduling is desired.

According to another aspect of the disclosure, the processing clients may be configured to send fewer than their entire weight parameters (e.g. artificial neural network weights) to the task model aggregator for model updating. The task model aggregator may then be configured to update its model based on the partial weights, rather than the entire weights. In so doing, the model may then be trained locally to obtain a balance between personalization and globalization.

The task model aggregator may combine or aggregate the received weights using a variety of techniques. In one example, the task model aggregator may aggregate the weights by averaging them, such as through an arithmetic mean. However, an arithmetic mean is not the only option for aggregation. The task model aggregator may compute any function on the weights rather than aggregating. Thus, generating an aggregate task model based on the received plurality of task models may include generating aggregate task model weights using the kernel mapping function or a transformation function. In some implementations, the task model aggregator may apply an artificial neural network to combine and/or distill the model updates.

In another example, instead of sending only the updated model weight parameters, the task model aggregator in general may optionally also provide additional feedback like hyperparameters. Hyperparameters may be understood as parameters control a machine learning process. These may be distinguished from the values of other parameters (typically node weights), which are derived via training. Sample hyperparameters for the task modeling system may include, but are not limited to, learning rate, or batch size. These hyperparameters may be helpful for local training at the client. In some instances, these hyperparameters may help processing clients better customize the local training of the model.

In many examples above, the task modeling system has been described as generating only a single global model. In some implementations, however, the task model aggregator may be configured to create multiple global models for a group of processing clients. The task modeling system may generate client-specific models. In this configuration, the task model aggregator may be configured to unicast the client-specific models rather than broadcasting a single global model for all processing clients. In some instances, this may be achieved with multitask learning procedures, in which the similarity between θᵢ and θⱼ is also updated at the task model aggregator between communication rounds based on weight updates and they are “merged/combined/aggregated” based on that similarity. In this manner, the new weights downloaded by the processing clients can also be client specific.

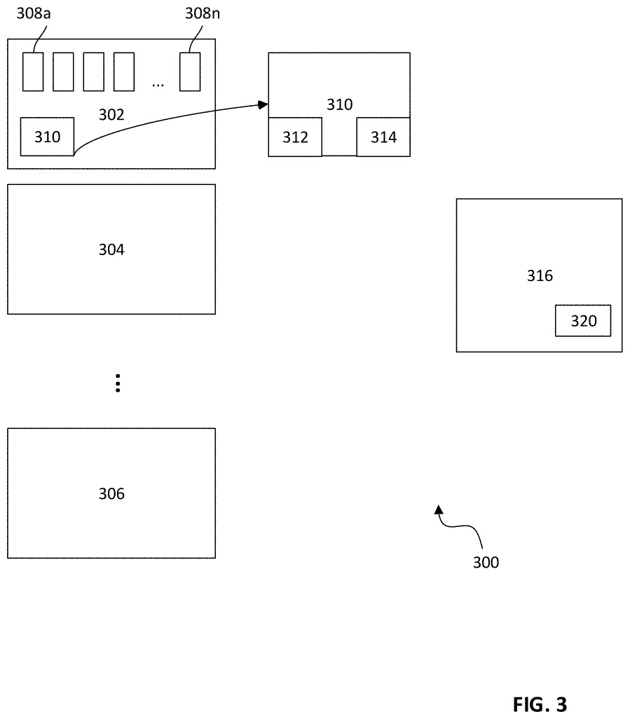

FIG. 3 depicts a task modeling system, according to a first implementation. This task modeling system may include a plurality of processing clients 302, 304, 306 (depicted herein as 3 processing clients, but may be any number of processing clients). Each processing client may include a plurality of processing cores (308a-308n) (the reference numbers 308a-308n are chosen for convenience, and the processing client may have any number of cores. Further, one or more processing clients may have a different number of cores than one or more other processing clients) and a task modeler 310. The task modeler 310 may include a memory 310, on which an artificial neural network is stored, and a processor 314. The processor 314 may be configured to receive input data representing a plurality of processing tasks to be completed by the processing client 302 among the plurality of processing cores 308a-308n within a predefined time duration. The processor 314 may be configured to implement its artificial neural network to determine from the input data an assignment of the processing tasks among the plurality of processing cores 308a-308n for completion of the processing tasks within the predefined time duration, and determine a power management factor for each of the plurality of processing cores for power management during the predefined time duration. In this manner, the artificial neural network may be configured to select the power management factor for each of the plurality of processing cores 308a-308n to achieve a power usage within a predefined threshold for the plurality of processing cores during the predefined duration. It is expressly noted that, although the plurality of processing cores 308a-308n, the task modeler 310, the memory 213, and the processor 314 are depicted only with respect to processing client 302, each of processing clients 304 and 306 (and any other processing clients of the plurality of processing clients) may also include each of these elements. The power usage within the predefined threshold may optionally be a minimum combined power usage.

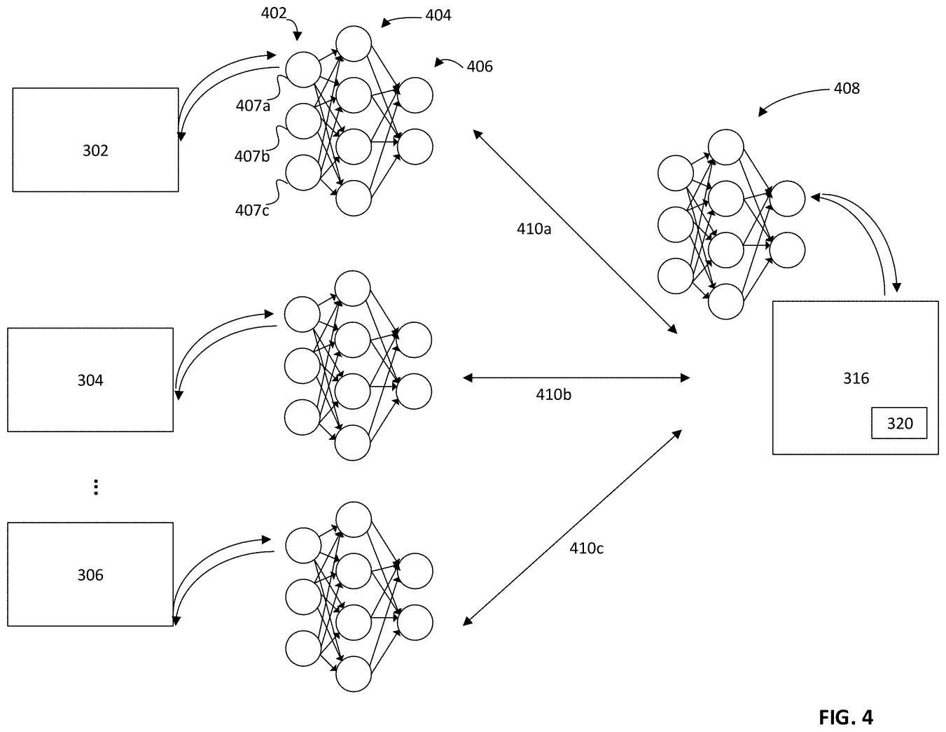

FIG. 4 depicts the artificial neural networks of the task modeling system. In this figure, the processing clients 302, 304, and 306 are depicted as each including an artificial neural network. As described above, the task modeler of each of the processing clients 302, 304, and 306 may implement an artificial neural network to determine from the input data the assignment of the processing tasks among the processing client's plurality of processing cores. The artificial neural networks as disclosed herein may optionally include an input layer 402, one or more middle layers 404 (e.g. hidden layers, depicted for convenience as including only a single layer, each artificial neural network may include any number of middle layers), and an output layer 406. The input layer 402 may include one or more nodes 407a, 407b, 407c. Each of the one or more middle layers may include one or more nodes (not labeled but corresponding to the nodes of 404), and each node of the one or more nodes may be associated with a weight, wherein the one or more middle layers are configured to receive data from the input layer and process the data according to the weighs. The output layer may be configured to receive the processed data from the one or more middle layers and to output the assignment of processing tasks and the power management factor for each of the plurality of processing cores. The task model data may optionally include weights of the artificial neural network of each task modeler.

In a second implementation, the task modeling system of the first implementation may optionally further include a task model aggregator 316. This task model aggregator 316 may include a processor 320. The task aggregator 316 may be configured to receive task model data from each of the plurality of task modelers (See 410a, 410b, and 410c, depicting transfer of the task model data from the processing clients). Using its processor 320, the task aggregator may generate an aggregate task model 408 based on the received plurality of task models, according to an aggregation rule.

The aggregation rule may be an arithmetic mean. In this manner, generating an aggregate task model based on the received plurality of task models may include generating aggregate task model weights as an average of the respective weights of the task model data of each of the plurality of processing clients. Alternatively or additionally, the aggregation rule may be a kernel mapping function. Such a kernel mapping function may permit operation in an implicit feature space by computing inner products between images of data pairs within the feature space, which may be computationally simpler actual computation of each coordinate. Alternatively or additionally, the aggregation rule may be or include a transformation function, wherein generating an aggregate task model based on the received plurality of task models includes generating aggregate task model weights using the kernel mapping function or a transformation function.

In a third implementation, and in combination with any of the above implementations, the task modeling system may optionally include, wherein each of the plurality of task modelers 310 (and corresponding task models in other processing clients) is further configured to receive the aggregate task model from the task model aggregator 316 (see sending of the aggregate task model from the task model aggregator to the processing clients as indicated by 410a, 410b, and 410c) and update one or more parameters of its respective artificial neural network based on the aggregate task model. In this manner, each client's task modeler 310 may receive updated information from the aggregate model, and using this updated information, the local task modeler 310 may determine the assignment of the processing tasks among the plurality of processing cores 302, 304, 306, etc. and the power management factor for each of the plurality of processing cores 302, 304, 306, etc. using the updated, global model. The task modelers (see 310) may be optionally configured to replace their respective task model with the aggregate task model. In this manner, the task modelers (see 310) of each respective client are updated with the global model, which is trained with a broader data set (e.g. based on models from each client) and therefore is more robust and may yield better results for a greater variety of novel inputs.

In a fourth implementation, the task modeling system of any of the above implementations may optionally be configured wherein the power management factor includes a clock speed of each core of the plurality of processing cores. Changing the clock speed is a known manner of power control. A slower clock speed reduces the rate with which the processor calculates. Since each calculation is associated with an energy expenditure, a reduction in clock speed is closely tied to a reduction in energy consumption.

In a fifth implementation, the task modeling system of any one of the above implementations may optionally include the power management factor including a duration for a processing core to enter a sleep mode. In various power management configurations, a processor may instruct a core to enter a sleep mode for a duration of time. The processor may calculate this duration of time based on any number of factors. The processor may optionally calculate the duration for the sleep more as part of the power management factor, in which the duration is a remaining portion of a time budget for a calculation, in which the core is not assigned a calculation.

In a sixth implementation, the task modeling system of any one of the above implementations may optionally include the power management factor being or include a voltage provided to each core of the plurality of processing cores. Another known method of power management in cores is to reduce the voltage provided to the core. A lower voltage may result in less current flowing through one or more transistors during processing operations, thereby reducing the overall power consumption.

In a seventh implementation, the task modeling system of any of the above implementations may optionally include that the artificial neural network stored on the memory of each task modeler is a feedforward artificial neural network. A feedforward artificial neural network may be an artificial neural network in which connections between nodes do not form a cycle. This may be distinguished from, for example, recurrent neural networks. In a feedforward artificial neural network, the information may travel along the nodes only in a forward direction and without cycles or loops. Such feedforward artificial neural networks may be simple to operate and train compared to other, more complex, artificial neural networks.

In an eighth implementation, any of the above implementations may be configured wherein the artificial neural network stored on the memory of each task modeler is a multilayer perceptron. A multilayer perceptron is a type of feedforward artificial neural network that include at least an input layer, a hidden layer, and an output layer. Except for the input nodes, each node is a neuron that uses a nonlinear activation function. A multilayer perceptron may be trained using a supervised learning technique (e.g. backpropagation).

In a ninth implementation, any of the above implementations may optionally be configured such that the artificial neural network is a a recurrent neural network. A recurrent neural network is a kind of artificial neural networks in which connections between nodes form a directed or undirected graph along a temporal sequence. Such connections permit the recurrent neural network to exhibit temporal dynamic behavior. Recurrent neural networks may use their internal state to process variable length sequences of inputs.

In a tenth implementation, the artificial neural network may be a deep learning transformer. A deep learning transformer may include a self-attention mechanism, in which the significance of input data is differentially. In this manner, the artificial neural network may be configured to utilize the deep learning transform to determine a significance of the various input date and to determine the assignment of the processing tasks and the power management factoring using the differentially weighted data.

In an eleventh implementation, the task modeling system of any of the above implementations may optionally include that the plurality of processing clients includes a first processing client and a second processing client. In this manner, a number of processing cores of the first processing client may be different from a number of processing cores of the second processing client. As such, the resulting models of the first processing core and the second processing core will differ. The processing cores will send these differing models to be aggregated. The task model aggregator will aggregate these models and generate therefrom a more robust model that will be capable of determining a task assignment and a power management factor on the first core and/or the second core, and will also be capable of interpolation, in which the model can determine acceptable task assignments and power management factors for a third core whose configurations lie between those of the first core and the second core.

In a twelfth implementation, the task modeling system of any of the above implementations may optionally include the plurality of processing clients including a first processing client and a second processing client, and wherein a power management factor implementable by a processing core of the first processing client is not implementable by a processing core of the second processing client. In this manner, the task modeling system may be configured to generate a task model that heterogeneous processing clients and/or processing clients with heterogeneous power management capabilities can use for task allocation and power management.

In a thirteenth implementation, the task modeling system of any one of the above implementations may optionally include wherein generating from the input data the assignment of processing tasks among the plurality of processing cores for completion within the predefined time duration includes interpolating the assignment within the artificial neural network. It is specifically expected that a client performing a task allocation exercise using some or all of the global model will encounter a novel situation that was not expressly considered by the global model (e.g. that was not part of the global model's training data). As such, the global model must be capable of generating a solution for novel data. Using the principles and methods disclosed herein, the global model can interpolate a task allocation solution and/or a power management factor.

In a fourteenth implementation, the task modeling system of any one of implementations three to thirteen may optionally include the task modeler of the plurality of task modelers further including a data filtering criterion. In this manner, the task modeler of the plurality of task modelers may be configured to determine a subset of values from the aggregate task model using the data filtering criterion, and the updating of the one or more parameters of its respective artificial neural network based on the aggregate task model may include updating the one or more parameters based on the subset of values. Depending on various factors, such as, for example, the number of processing clients whose data is used to train the global model, the global model may become quite large. If the global model is quite large, it may be impractical for the processing clients to download the complete global model, particularly for the iterative training procedure disclosed herein, in which multiple downloads would often occur. To simplify the download and/or to shorten the download time, the task modelers may include data filtering criteria. The global model may be configured to be filterable by the data filtering criteria, such that the processing clients may download only a subset of the global model data. In an exemplary configuration, a task modeler of a client may send data filtering criteria (or a data filtering criterion) to the task model aggregator, which then may select a subset of the global model for download by the client/task modeler.

The plurality of processing tasks disclosed herein may optionally be baseband processing tasks according to a wireless radio access technology. For example, these processing tasks may optionally be processing tasks according to a Layer 1 implementation of 4G physical layer baseband processing, according to a Layer 2 implementation of 4G physical layer baseband processing, according to a Layer 1 implementation of 5G physical layer baseband processing, according to a Layer 2 implementation of 5G physical layer baseband processing, according to a Layer 1 implementation of 6G physical layer baseband processing, according to a Layer 2 implementation of 6G physical layer baseband processing, or any of these.

The artificial neural network may include a plurality of weight parameters. Receiving the task model data from each of the plurality of task modelers may include receiving each weight parameter of each artificial neural network. The artificial neural network may optionally include a plurality of weight parameters, and receiving the task model data from each of the plurality of task modelers may include receiving fewer than each weight parameter of each artificial neural network. The task model aggregator may be configured to generate the aggregate task model based on the fewer than each weight parameter of each artificial neural network. In this manner, updating the one or more parameters of the respective artificial neural network based on the aggregate task model may optionally include updating the one or more parameters based on the aggregate task model based on the fewer than each weight parameter of each artificial neural network.

The task model aggregator may include a memory on which an aggregating artificial neural network is stored. In this manner, generating the aggregate task model may include the task model aggregator aggregating the task model data using the aggregating artificial neural network. The task modeling system of any one of the above implementations may optionally include that receiving task model data from each of the plurality of task modelers includes receiving learning rate and/or batch size. The task modeling system may optionally include the task model aggregator being configured to generate a plurality of aggregate task models from the received plurality of task models; and the task model aggregator may generate each aggregate task model according to a client factor, wherein the client factor includes a processing client identity and/or one or more processing client preferences. The processing tasks may optionally include a first processing task and a second processing task, wherein the first processing task must be performed before the second processing task can be performed, and wherein determining from the input data the assignment of the processing tasks further includes determining an order of the processing tasks wherein a core performs a first processing task before performing the second processing task.

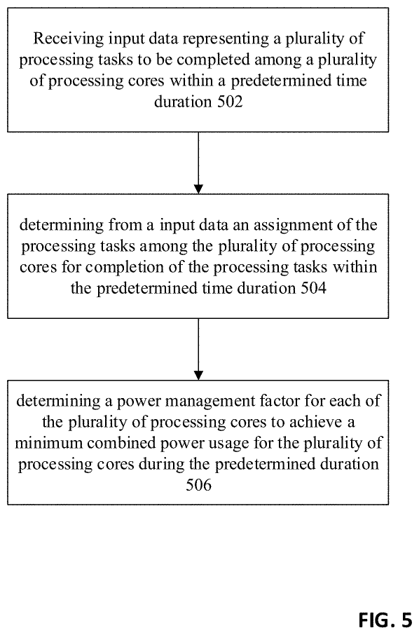

FIG. 5 depicts a method of task modeling, including receiving input data representing a plurality of processing tasks to be completed among a plurality of processing cores within a predefined time duration 502; determining from a input data an assignment of the processing tasks among the plurality of processing cores for completion of the processing tasks within the predefined time duration 504, and determining a power management factor for each of the plurality of processing cores to achieve a power usage within a predefined threshold for the plurality of processing cores during the predefined duration 506. The method of task modeling may optionally further include receiving task model data from each of the plurality of task modelers; and generating an aggregate task model based on the received plurality of task models, according to an aggregation rule. The method of task modeling may optionally further include receiving the aggregate task model and updating one or more parameters of its respective artificial neural network based on the aggregate task model. The power usage within the predefined threshold may optionally be a minimum combined power usage.

Further aspects of the disclosure will now be stated via example:

In Example 1, a task modeling system, including: a plurality of processing clients, each processing client including: a plurality of processing cores; and a task modeler, including: a memory, on which an artificial neural network is stored; and a processor, configured to: receive input data representing a plurality of processing tasks to be completed by the processing client among the plurality of processing cores within a predefined time duration; and implement its artificial neural network to: determine from the input data an assignment of the processing tasks among the plurality of processing cores for completion of the processing tasks within the predefined time duration, and determine a power management factor for each of the plurality of processing cores for power management during the predefined time duration; wherein the artificial neural network is configured to select the power management factor for each of the plurality of processing cores to achieve a power usage within a predefined threshold for the plurality of processing cores during the predefined duration. The power usage within the predefined threshold may optionally be a minimum combined power usage.

In Example 2, the task modeling system of Example 1, further including: a task model aggregator, including a processor, configured to: receive task model data from each of the plurality of task modelers; and generate an aggregate task model based on the received plurality of task models, according to an aggregation rule.

In Example 3, the task modeling system of Example 2, wherein each of the plurality of task modelers is further configured to receive the aggregate task model from the task model aggregator and update one or more parameters of its respective artificial neural network based on the aggregate task model.

In Example 4, the task modeling system of Example 2, wherein each of the plurality of task modelers is further configured to receive the aggregate task model from the task model aggregator and to replace a task model of its respective artificial neural network with the aggregate task model.

In Example 5, the task modeling system of any one of Examples 1 to 4, wherein the artificial neural network of each task modeler includes: an input layer, including one or more nodes; one or more middle layers, each of the one or more middle layers including one or more nodes, and each node of the one or more nodes being associated with a weight, wherein the one or more middle layers are configured to receive data from the input layer and process the data according to the weighs; and an output layer, configured to receive the processed data from the one or more middle layers and output the assignment of processing tasks and the power management factor for each of the plurality of processing cores.

In Example 6, the task modeling system of Example 5, wherein the task model data include weights of the artificial neural network of each task modeler.

In Example 7, the task modeling system of Example 6, wherein the aggregation rule is an arithmetic mean, and wherein generating an aggregate task model based on the received plurality of task models includes generating an aggregate task model weights as an average of the respective weights of the task model data of each of the plurality of processing clients.

In Example 8, the task modeling system of Example 6, wherein the aggregation rule is a kernel mapping function or a transformation function, and wherein generating an aggregate task model based on the received plurality of task models includes generating aggregate task model weights using the kernel mapping function or a transformation function.

In Example 9, the task modeling system of any one of Examples 1 to 8, wherein the power management factor includes a clock speed of each core of the plurality of processing cores.

In Example 10, the task modeling system of any one of Examples 1 to 9, wherein the power management factor includes a duration for a processing core to enter a sleep mode.

In Example 11, the task modeling system of any one of Examples 1 to 10, wherein the power management factor includes a voltage provided to each core of the plurality of processing cores.

In Example 12, the task modeling system of any one of Examples 1 to 11, wherein the artificial neural network stored on the memory of each task modeler is a feedforward artificial neural network.

In Example 13, the task modeling system of Example 12, wherein the artificial neural network stored on the memory of each task modeler is a multilayer perceptron.

In Example 14, the task modeling system of any one of Examples 1 to 11, wherein the artificial neural network stored on the memory of each task modeler is a recurrent neural network.

In Example 15, the task modeling system of any one of Examples 1 to 11, wherein the artificial neural network stored on the memory of each task modeler is deep learning transformer.

In Example 16, the task modeling system of any one of Examples 1 to 15, wherein the plurality of processing clients includes a first processing client and a second processing client, and wherein a number of processing cores of the first processing client is different from a number of processing cores of the second processing client.

In Example 17, the task modeling system of any one of Examples 1 to 16, wherein the plurality of processing clients includes a first processing client and a second processing client, and wherein a power management factor implementable by a processing core of the first processing client is not implementable by a processing core of the second processing client.

In Example 18, the task modeling system of any one of Examples 1 to 17, wherein generating from the input data the assignment of processing tasks among the plurality of processing cores for completion within the predefined time duration includes interpolating the assignment within the artificial neural network.

In Example 19, the task modeling system of any one of Examples 3 to 18, wherein a task modeler of the plurality of task modelers further includes a data filtering criterion, and wherein the task modeler of the plurality of task modelers is configured to determine a subset of values from the aggregate task model using the data filtering criterion, and wherein the updating one or more parameters of its respective artificial neural network based on the aggregate task model includes updating the one or more parameters based on the subset of values.

In Example 20, the task modeling system of any one of Examples 1 to 19, wherein the plurality of processing tasks are baseband processing tasks according to a wireless radio access technology.

In Example 21, the task modeling system of Example 20, wherein the plurality of processing tasks are baseband processing tasks according to a Layer 1 or Layer 2 implementation of a 4G or 5G physical layer baseband processing.

In Example 22, the task modeling system of any one of Examples 2 to 21, wherein the artificial neural network includes a plurality of weight parameters, and wherein receiving the task model data from each of the plurality of task modelers includes receiving each weight parameter of each artificial neural network.

In Example 23, the task modeling system of any one of Examples 2 to 21, wherein the artificial neural network includes a plurality of weight parameters, and wherein receiving the task model data from each of the plurality of task modelers includes receiving fewer than each weight parameter of each artificial neural network, and wherein the task model aggregator is configured to generate the aggregate task model based on the fewer than each weight parameter of each artificial neural network.

In Example 24, the task modeling system of Example 23, wherein updating the one or more parameters of the respective artificial neural network based on the aggregate task model includes updating the one or more parameters based on the aggregate task model based on the fewer than each weight parameter of each artificial neural network.

In Example 25, the task modeling system of any one of Examples 2 to 24, wherein the task model aggregator includes a memory on which an aggregating artificial neural network is stored, and wherein generating the aggregate task model includes the task model aggregator aggregating the task model data using the aggregating artificial neural network.

In Example 26, the task modeling system of any one of Examples 2 to 25, wherein receiving task model data from each of the plurality of task modelers includes receiving learning rate and/or batch size.

In Example 27, the task modeling system of any one of Examples 2 to 26, wherein the task model aggregator is configured to generate a plurality of aggregate task models from the received plurality of task models; and wherein the task model aggregator generates each aggregate task model according to a client factor, wherein the client factor includes a processing client identity and/or one or more processing client preferences.

In Example 28, the task modeling system of any one of Examples 1 to 27, wherein the processing tasks include a first processing task and a second processing task, wherein the first processing task must be performed before the second processing task can be performed, and wherein determining from the input data the assignment of the processing tasks further includes determining an order of the processing tasks wherein a core performs to first processing task before performing the second processing task.

In Example 28a, the task modeling system any of any one of Examples 1 to 28 may include the processor being configured to receive the input data representing the plurality of processing tasks to be completed by the processing client in which the processing tasks are given in a specific order of task execution to account for one or more task dependencies. In this manner, any element of the task modeling system may be configured to determine an assignment of the processing tasks that considers and/or satisfies any task dependencies (e.g. tasks that must be completed before one or more other tasks).

In Example 29, a task model aggregator, including a processor, configured to: receive task model data from each of a plurality of task modelers, wherein the task model data represent weights of an artificial neural network of each of the task modelers; and generate an aggregate task model based on the received plurality of task models, according to an aggregation rule.

In Example 30, the task model aggregator of Example 29, wherein the task model data include weights of the artificial neural network of each task modeler, wherein the aggregation rule is an arithmetic mean, and wherein generating an aggregate task model based on the received plurality of task models includes generating an aggregate task model weights as an average of the respective weights of the task model data of each of the plurality of processing clients.

In Example 31, the task model aggregator of any one of Examples 30 to 30, wherein the artificial neural network includes a plurality of weight parameters, and wherein receiving the task model data from each of the plurality of task modelers includes receiving each weight parameter of each artificial neural network.

In Example 32, the task model aggregator of any one of Examples 30 to 30, wherein the artificial neural network includes a plurality of weight parameters, and wherein receiving the task model data from each of the plurality of task modelers includes receiving fewer than each weight parameter of each artificial neural network, and wherein the task model aggregator is configured to generate the aggregate task model based on the fewer than each weight parameter of each artificial neural network.

In Example 33, the task model aggregator of any one of Examples 30 to 32, wherein the task model aggregator includes a memory on which an aggregating artificial neural network is sorted, and wherein generating the aggregate task model includes the task model aggregator aggregating the task model data using the aggregating artificial neural network.

In Example 34, the task model aggregator of any one of Examples 30 to 33, wherein receiving task model data from each of the plurality of task modelers includes receiving learning rate and/or batch size.

In Example 35, the task model aggregator of any one of Examples 30 to 34, wherein the task model aggregator is configured to generate a plurality of aggregate task models from the received plurality of task models; and wherein the task model aggregator generates each aggregate task model according to a client factor, wherein the client factor includes a processing client identity and/or one or more processing client preferences.

In Example 36, a task modeler, including: a plurality of processing clients, each processing client including: a plurality of processing cores; and a task modeler, including: a memory, on which an artificial neural network is stored; and a processor, configured to: receive input data representing a plurality of processing tasks to be completed by the processing client among the plurality of processing cores within a predefined time duration; and implement its artificial neural network to: determine from the input data an assignment of the processing tasks among the plurality of processing cores for completion of the processing tasks within the predefined time duration, and determine a power management factor for each of the plurality of processing cores for power management during the predefined time duration; wherein the artificial neural network is configured to select the power management factor for each of the plurality of processing cores to achieve a power usage within a predefined threshold for the plurality of processing cores during the predefined duration. The power usage within the predefined threshold may optionally be a minimum combined power usage.

In Example 37, the task modeler of Example 36, further including: a task model aggregator, including a processor, configured to: receive task model data from each of the plurality of task modelers; and generate an aggregate task model based on the received plurality of task models, according to an aggregation rule.

In Example 38, the task modeler of Example 37, wherein each of the plurality of task modelers is further configured to receive the aggregate task model from the task model aggregator and update one or more parameters of its respective artificial neural network based on the aggregate task model.

In Example 39, the task modeler of Example 37, wherein each of the plurality of task modelers is further configured to receive the aggregate task model from the task model aggregator and to replace a task model of its respective artificial neural network with the aggregate task model.

In Example 40, the task modeler of any one of Examples 36 to 39, wherein the artificial neural network of each task modeler includes: an input layer, including one or more nodes; one or more middle layers, each of the one or more middle layers including one or more nodes, and each node of the one or more nodes being associated with a weight, wherein the one or more middle layers are configured to receive data from the input layer and process the data according to the weighs; and an output layer, configured to receive the processed data from the one or more middle layers and output the assignment of processing tasks and the power management factor for each of the plurality of processing cores.

In Example 41, the task modeler of Example 40, wherein the task model data include weights of the artificial neural network of each task modeler.

In Example 42, the task modeler of Example 41, wherein the aggregation rule is an arithmetic mean, and wherein generating an aggregate task model based on the received plurality of task models includes generating an aggregate task model weights as an average of the respective weights of the task model data of each of the plurality of processing clients.

In Example 43, the task modeler of Example 41, wherein the aggregation rule is a kernel mapping function or a transformation function, and wherein generating an aggregate task model based on the received plurality of task models includes generating aggregate task model weights using the kernel mapping function or a transformation function.

In Example 44, the task modeler of any one of Examples 36 to 43, wherein the power management factor includes a clock speed of each core of the plurality of processing cores.

In Example 45, the task modeler of any one of Examples 36 to 44, wherein the power management factor includes a duration for a processing core to enter a sleep mode.

In Example 46, the task modeler of any one of Examples 36 to 45, wherein the power management factor includes a voltage provided to each core of the plurality of processing cores.

In Example 47, the task modeler of any one of Examples 36 to 46, wherein the artificial neural network stored on the memory of each task modeler is a feedforward artificial neural network.

In Example 48, the task modeler of Example 47, wherein the artificial neural network stored on the memory of each task modeler is a multilayer perceptron.

In Example 49, the task modeler of any one of Examples 36 to 46, wherein the artificial neural network stored on the memory of each task modeler is a recurrent neural network.

In Example 50, the task modeler of any one of Examples 36 to 46, wherein the artificial neural network stored on the memory of each task modeler is deep learning transformer.

In Example 51, the task modeler of any one of Examples 36 to 50, wherein the plurality of processing clients includes a first processing client and a second processing client, and wherein a number of processing cores of the first processing client is different from a number of processing cores of the second processing client.

In Example 52, the task modeler of any one of Examples 36 to 51, wherein the plurality of processing clients includes a first processing client and a second processing client, and wherein a power management factor implementable by a processing core of the first processing client is not implementable by a processing core of the second processing client.

In Example 53, the task modeler of any one of Examples 36 to 52, wherein generating from the input data the assignment of processing tasks among the plurality of processing cores for completion within the predefined time duration includes interpolating the assignment within the artificial neural network.

In Example 54, the task modeler of any one of Examples 38 to 53, wherein a task modeler of the plurality of task modelers further includes a data filtering criterion, and wherein the task modeler of the plurality of task modelers is configured to determine a subset of values from the aggregate task model using the data filtering criterion, and wherein the updating one or more parameters of its respective artificial neural network based on the aggregate task model includes updating the one or more parameters based on the subset of values.

In Example 55, the task modeler of any one of Examples 36 to 54, wherein the plurality of processing tasks are baseband processing tasks according to a wireless radio access technology.

In Example 56, the task modeler of Example 55, wherein the plurality of processing tasks are baseband processing tasks according to a Layer 1 or Layer 2 implementation of a 4G or 5G physical layer baseband processing.

In Example 57, the task modeler of any one of Examples 37 to 56, wherein the artificial neural network includes a plurality of weight parameters, and wherein receiving the task model data from each of the plurality of task modelers includes receiving each weight parameter of each artificial neural network.

In Example 58, the task modeler of any one of Examples 37 to 56, wherein the artificial neural network includes a plurality of weight parameters, and wherein receiving the task model data from each of the plurality of task modelers includes receiving fewer than each weight parameter of each artificial neural network, and wherein the task model aggregator is configured to generate the aggregate task model based on the fewer than each weight parameter of each artificial neural network.

In Example 59, the task modeler of Example 58, wherein updating the one or more parameters of the respective artificial neural network based on the aggregate task model includes updating the one or more parameters based on the aggregate task model based on the fewer than each weight parameter of each artificial neural network.

In Example 60, the task modeler of any one of Examples 37 to 59, wherein the task model aggregator includes a memory on which an aggregating artificial neural network is stored, and wherein generating the aggregate task model includes the task model aggregator aggregating the task model data using the aggregating artificial neural network.

In Example 61, the task modeler of any one of Examples 37 to 60, wherein receiving task model data from each of the plurality of task modelers includes receiving learning rate and/or batch size.

In Example 62, the task modeler of any one of Examples 37 to 61, wherein the task model aggregator is configured to generate a plurality of aggregate task models from the received plurality of task models; and wherein the task model aggregator generates each aggregate task model according to a client factor, wherein the client factor includes a processing client identity and/or one or more processing client preferences.

In Example 63, the task modeler of any one of Examples 36 to 62, wherein the processing tasks include a first processing task and a second processing task, wherein the first processing task must be performed before the second processing task can be performed, and wherein determining from the input data the assignment of the processing tasks further includes determining an order of the processing tasks wherein a core performs to first processing task before performing the second processing task.

In Example 63a, the task modeler any of any one of Examples 36 to 62 may include the processor being configured to receive the input data representing the plurality of processing tasks to be completed by the processing client in which the processing tasks are given in a specific order of task execution to account for one or more task dependencies. In this manner, any element of the task modeling system may be configured to determine an assignment of the processing tasks that considers and/or satisfies any task dependencies (e.g. tasks that must be completed before one or more other tasks).

In Example 64, a task model aggregator, including a processor, configured to receive task model data from each of a plurality of task modelers, wherein the task model data represent weights of an artificial neural network of each of the task modelers; and generate an aggregate task model based on the received plurality of task models, according to an aggregation rule.

In Example 65, the task model aggregator of Example 64, wherein the task model data include weights of the artificial neural network of each task modeler, wherein the aggregation rule is an arithmetic mean, and wherein generating an aggregate task model based on the received plurality of task models includes generating an aggregate task model weights as an average of the respective weights of the task model data of each of the plurality of processing clients.

In Example 66, the task model aggregator of any one of Examples 65 to 65, wherein the artificial neural network includes a plurality of weight parameters, and wherein receiving the task model data from each of the plurality of task modelers includes receiving each weight parameter of each artificial neural network.

In Example 67, the task model aggregator of any one of Examples 65 to 65, wherein the artificial neural network includes a plurality of weight parameters, and wherein receiving the task model data from each of the plurality of task modelers includes receiving fewer than each weight parameter of each artificial neural network, and wherein the task model aggregator is configured to generate the aggregate task model based on the fewer than each weight parameter of each artificial neural network.

In Example 68, the task model aggregator of any one of Examples 65 to 67, wherein the task model aggregator includes a memory on which an aggregating artificial neural network is sorted, and wherein generating the aggregate task model includes the task model aggregator aggregating the task model data using the aggregating artificial neural network.

In Example 69, the task model aggregator of any one of Examples 65 to 68, wherein receiving task model data from each of the plurality of task modelers includes receiving learning rate and/or batch size.

In Example 70, the task model aggregator of any one of Examples 65 to 69, wherein the task model aggregator is configured to generate a plurality of aggregate task models from the received plurality of task models; and wherein the task model aggregator generates each aggregate task model according to a client factor, wherein the client factor includes a processing client identity and/or one or more processing client preferences.

In Example 71, a task modeling system, including: a plurality of processing client, each processing client including: a plurality of processing cores, for task processing; and a task modeling means, for generating a task allocation model, including: a data storage means for storing an artificial neural network; and a processing means, for: receiving input data representing a plurality of processing tasks to be completed by the processing client among the plurality of processing cores within a predefined time duration; and implementing its artificial neural network to: determine from the input data an assignment of the processing tasks among the plurality of processing cores for completion of the processing tasks within the predefined time duration, and determine a power management factor for each of the plurality of processing cores for power management during the predefined time duration; wherein the artificial neural network is configured to select the power management factor for each of the plurality of processing cores to achieve a power usage within a determined threshold for the plurality of processing cores during the predefined duration. The power usage within the predefined threshold may optionally be a minimum combined power usage.

In Example 72, the task modeling system of Example 71, further including: a task model aggregation means, for receiving task model data from each of the plurality of task modeling means; and generating an aggregate task model based on the received plurality of task models, according to an aggregation rule.

In Example 73, the task modeling system of Example 72, wherein each of the plurality of task modeling means is further configured to receive the aggregate task model from the task model aggregator and update one or more parameters of its respective artificial neural network based on the aggregate task model.

In Example 74, the task modeling system of Example 72, wherein each of the plurality of task modeling means is further configured to receive the aggregate task model from the task model aggregator and to replace a task model of its respective artificial neural network with the aggregate task model.

In Example 75, the task modeling system of any one of Examples 71 to 74, wherein the artificial neural network of each task modeling means includes: an input layer, including one or more nodes; one or more middle layers, each of the one or more middle layers including one or more nodes, and each node of the one or more nodes being associated with a weight, wherein the one or more middle layers are configured to receive data from the input layer and process the data according to the weighs; and an output layer, configured to receive the processed data from the one or more middle layers and output the assignment of processing tasks and the power management factor for each of the plurality of processing cores.

In Example 76, the task modeling system of Example 75, wherein the task model data include weights of the artificial neural network of each task modeling means.

In Example 77, the task modeling system of Example 76, wherein the aggregation rule is an arithmetic mean, and wherein generating an aggregate task model based on the received plurality of task models includes generating an aggregate task model weights as an average of the respective weights of the task model data of each of the plurality of processing clients.

In Example 78, the task modeling system of Example 76, wherein the aggregation rule is a kernel mapping function or a transformation function, and wherein generating an aggregate task model based on the received plurality of task models includes generating aggregate task model weights using the kernel mapping function or a transformation function.

In Example 79, the task modeling system of any one of Examples 71 to 78, wherein the power management factor includes a clock speed of each core of the plurality of processing cores.

In Example 80, the task modeling system of any one of Examples 71 to 79, wherein the power management factor includes a duration for a processing core to enter a sleep mode.

In Example 81, the task modeling system of any one of Examples 71 to 80, wherein the power management factor includes a voltage provided to each core of the plurality of processing cores.

In Example 82, the task modeling system of any one of Examples 71 to 81, wherein the artificial neural network stored on the memory of each task modeling means is a feedforward artificial neural network.

In Example 83, the task modeling system of Example 82, wherein the artificial neural network stored on the memory of each task modeling means is a multilayer perceptron.

In Example 84, the task modeling system of any one of Examples 71 to 81, wherein the artificial neural network stored on the memory of each task modeling means is a recurrent neural network.

In Example 85, the task modeling system of any one of Examples 71 to 81, wherein the artificial neural network stored on the memory of each task modeling means is deep learning transformer.

In Example 86, the task modeling system of any one of Examples 71 to 85, wherein the plurality of processing clients includes a first processing client and a second processing client, and wherein a number of processing cores of the first processing client is different from a number of processing cores of the second processing client.

In Example 87, the task modeling system of any one of Examples 71 to 86, wherein the plurality of processing clients includes a first processing client and a second processing client, and wherein a power management factor implementable by a processing core of the first processing client is not implementable by a processing core of the second processing client.

In Example 88, the task modeling system of any one of Examples 71 to 87, wherein generating from the input data the assignment of processing tasks among the plurality of processing cores for completion within the predefined time duration includes interpolating the assignment within the artificial neural network.

In Example 89, the task modeling system of any one of Examples 73 to 88, wherein a task modeling means of the plurality of task modeling means further includes a data filtering criterion, and wherein the task modeling means of the plurality of task modeling means is configured to determine a subset of values from the aggregate task model using the data filtering criterion, and wherein the updating one or more parameters of its respective artificial neural network based on the aggregate task model includes updating the one or more parameters based on the subset of values.

In Example 90, the task modeling system of any one of Examples 71 to 89, wherein the plurality of processing tasks are baseband processing tasks according to a wireless radio access technology.

In Example 91, the task modeling system of Example 90, wherein the plurality of processing tasks are baseband processing tasks according to a Layer 1 or Layer 2 implementation of a 4G or 5G physical layer baseband processing.

In Example 92, the task modeling system of any one of Examples 72 to 91, wherein the artificial neural network includes a plurality of weight parameters, and wherein receiving the task model data from each of the plurality of task modeling means includes receiving each weight parameter of each artificial neural network.

In Example 93, the task modeling system of any one of Examples 72 to 91, wherein the artificial neural network includes a plurality of weight parameters, and wherein receiving the task model data from each of the plurality of task modeling means includes receiving fewer than each weight parameter of each artificial neural network, and wherein the task model aggregator is configured to generate the aggregate task model based on the fewer than each weight parameter of each artificial neural network.

In Example 94, the task modeling system of Example 93, wherein updating the one or more parameters of the respective artificial neural network based on the aggregate task model includes updating the one or more parameters based on the aggregate task model based on the fewer than each weight parameter of each artificial neural network.

In Example 95, the task modeling system of any one of Examples 72 to 94, wherein the task model aggregator includes a memory on which an aggregating artificial neural network is stored, and wherein generating the aggregate task model includes the task model aggregator aggregating the task model data using the aggregating artificial neural network.

In Example 96, the task modeling system of any one of Examples 72 to 95, wherein receiving task model data from each of the plurality of task modeling means includes receiving learning rate and/or batch size.

In Example 97, the task modeling system of any one of Examples 72 to 96, wherein the task model aggregator is configured to generate a plurality of aggregate task models from the received plurality of task models; and wherein the task model aggregator generates each aggregate task model according to a client factor, wherein the client factor includes a processing client identity and/or one or more processing client preferences.

In Example 98, the task modeling system of any one of Examples 71 to 97, wherein the processing tasks include a first processing task and a second processing task, wherein the first processing task must be performed before the second processing task can be performed, and wherein determining from the input data the assignment of the processing tasks further includes determining an order of the processing tasks wherein a core performs to first processing task before performing the second processing task.

In Example 99, a task model aggregator, including a processing means, configured to: receive task model data from each of a plurality of task modeling means, wherein the task model data represent weights of an artificial neural network of each of the task modeling means; and generate an aggregate task model based on the received plurality of task models, according to an aggregation rule.

In Example 100, the task model aggregator of Example 99, wherein the task model data include weights of the artificial neural network of each task modeling means, wherein the aggregation rule is an arithmetic mean, and wherein generating an aggregate task model based on the received plurality of task models includes generating an aggregate task model weights as an average of the respective weights of the task model data of each of the plurality of processing clients.

In Example 101, the task model aggregator of any one of Examples 100 to 100, wherein the artificial neural network includes a plurality of weight parameters, and wherein receiving the task model data from each of the plurality of task modeling means includes receiving each weight parameter of each artificial neural network.

In Example 102, the task model aggregator of any one of Examples 100 to 100, wherein the artificial neural network includes a plurality of weight parameters, and wherein receiving the task model data from each of the plurality of task modeling means includes receiving fewer than each weight parameter of each artificial neural network, and wherein the task model aggregator is configured to generate the aggregate task model based on the fewer than each weight parameter of each artificial neural network.

In Example 103, the task model aggregator of any one of Examples 100 to 102, wherein the task model aggregator includes a memory on which an aggregating artificial neural network is sorted, and wherein generating the aggregate task model includes the task model aggregator aggregating the task model data using the aggregating artificial neural network.

In Example 104, the task model aggregator of any one of Examples 100 to 103, wherein receiving task model data from each of the plurality of task modeling means includes receiving learning rate and/or batch size.

In Example 105, the task model aggregator of any one of Examples 100 to 104, wherein the task model aggregator is configured to generate a plurality of aggregate task models from the received plurality of task models; and wherein the task model aggregator generates each aggregate task model according to a client factor, wherein the client factor includes a processing client identity and/or one or more processing client preferences.

In Example 106, a method of task modeling, including: receiving input data representing a plurality of processing tasks to be completed among a plurality of processing cores within a predefined time duration; and determining from a input data an assignment of the processing tasks among the plurality of processing cores for completion of the processing tasks within the predefined time duration, and determining a power management factor for each of the plurality of processing cores to achieve a power usage within a predefined threshold for the plurality of processing cores during the predefined duration. The power usage within the predefined threshold may optionally be a minimum combined power usage.

In Example 107, the method of task modeling of Example 106, further including: receiving task model data from each of the plurality of task modelers; and generating an aggregate task model based on the received plurality of task models, according to an aggregation rule.

In Example 108, the method of task modeling of Example 107, further including receiving the aggregate task model and updating one or more parameters of its respective artificial neural network based on the aggregate task model.

In Example 109, the method of task modeling of Example 107, further including receiving the aggregate task model and replacing a task model of its respective artificial neural network with the aggregate task model.

In Example 110, the method of task modeling of Example 106, wherein the aggregation rule is an arithmetic mean, and wherein generating an aggregate task model based on the received plurality of task models includes generating an aggregate task model weights as an average of the respective weights of the task model data of each of the plurality of processing clients.

In Example 111, the method of task modeling of Example 106, wherein the aggregation rule is a kernel mapping function or a transformation function, and wherein generating an aggregate task model based on the received plurality of task models includes generating aggregate task model weights using the kernel mapping function or a transformation function.

In Example 112, the method of task modeling of any one of Examples 106 to 111, wherein the power management factor includes a clock speed of each core of the plurality of processing cores.

In Example 113, the method of task modeling of any one of Examples 106 to 111, wherein the power management factor includes a duration for a processing core to enter a sleep mode.

In Example 114, the method of task modeling of any one of Examples 106 to 113, wherein the power management factor includes a voltage provided to each core of the plurality of processing cores.

In Example 115, the method of task modeling of any one of Examples 106 to 114, wherein generating from the input data the assignment of processing tasks among the plurality of processing cores for completion within the predefined time duration includes interpolating the assignment within an artificial neural network.

In Example 116, the method of task modeling of any one of Examples 108 to 115, further including a data filtering criterion, and further including determining a subset of values from the aggregate task model using the data filtering criterion, and wherein the updating one or more parameters of its respective artificial neural network based on the aggregate task model includes updating the one or more parameters based on the subset of values.

In Example 117, the method of task modeling of any one of Examples 106 to 116, wherein the plurality of processing tasks are baseband processing tasks according to a wireless radio access technology.

In Example 118, the method of task modeling of Example 117, wherein the plurality of processing tasks are baseband processing tasks according to a Layer 1 or Layer 2 implementation of a 4G or 5G physical layer baseband processing.

In Example 119, the method of task modeling of any one of Examples 107 to 118, wherein receiving task model data from each of the plurality of task modelers includes receiving learning rate and/or batch size.

In Example 120, the method of task modeling of any one of Examples 107 to 119, further including generating a plurality of aggregate task models from the received plurality of task models; and generating each aggregate task model according to a client factor, wherein the client factor includes a processing client identity and/or one or more processing client preferences.

In Example 121, the method of task modeling of any one of Examples 106 to 120, wherein the processing tasks include a first processing task and a second processing task, wherein the first processing task must be performed before the second processing task can be performed, and wherein determining from the input data the assignment of the processing tasks further includes determining an order of the processing tasks wherein a core performs to first processing task before performing the second processing task.

In Example 122, a non-transitory computer readable medium including instructions which, when executed, cause a processor to perform the method of any one of examples 100 to 121.

While the above descriptions and connected figures may depict components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

What is claimed is:

1. A task modeling system, comprising:
a plurality of processing clients, each processing client comprising:
a plurality of processing cores; and
a task modeler, comprising:
a memory, on which an artificial neural network is stored; and
a processor, configured to:
receive input data representing a plurality of processing tasks to be completed by the processing client among the plurality of processing cores over a predefined time duration; and
implement its artificial neural network to:
determine from the input data an assignment of the processing tasks among the plurality of processing cores for completion of the processing tasks over the predefined time duration, and
determine a power management factor for each of the plurality of processing cores for power management during the predefined time duration;
wherein the artificial neural network is configured to select the power management factor for each of the plurality of processing cores to achieve a combined power usage within a predefined threshold for the plurality of processing cores during the predefined duration.

2. The task modeling system of claim 1, further comprising:
a task model aggregator, comprising a processor, configured to:
receive task model data from each of the plurality of task modelers; and
generate an aggregate task model based on the received plurality of task models, according to an aggregation rule.

3. The task modeling system of claim 2, wherein each of the plurality of task modelers is further configured to receive the aggregate task model from the task model aggregator and update one or more parameters of its respective artificial neural network based on the aggregate task model, or to replace a task model of its respective artificial neural network with the aggregate task model.

4. The task modeling system of claim 1, wherein the artificial neural network of each task modeler comprises:
an input layer, comprising one or more nodes;
one or more middle layers, each of the one or more middle layers comprising one or more nodes, and each node of the one or more nodes being associated with a weight, wherein the one or more middle layers are configured to receive data from the input layer and process the data according to the weighs; and
an output layer, configured to receive the processed data from the one or more middle layers and output the assignment of processing tasks and the power management factor for each of the plurality of processing cores.

5. The task modeling system of claim 4, wherein the task model data comprise weights of the artificial neural network of each task modeler, and wherein the aggregation rule is an arithmetic mean, and wherein generating an aggregate task model based on the received plurality of task models comprises generating an aggregate task model weights as an average of the respective weights of the task model data of each of the plurality of processing clients.

6. The task modeling system of claim 5, wherein the task model data comprise weights of the artificial neural network of each task modeler, and wherein the aggregation rule is a kernel mapping function or a transformation function, and wherein generating an aggregate task model based on the received plurality of task models comprises generating aggregate task model weights using the kernel mapping function or a transformation function.

7. The task modeling system of claim 1, wherein the power management factor comprises a clock speed of each core of the plurality of processing cores; a duration for a processing core to enter a sleep mode, or a voltage provided to each core of the plurality of processing cores.

8. The task modeling system of claim 1, wherein the artificial neural network stored on the memory of each task modeler is a feedforward artificial neural network, a multilayer perceptron, a recurrent neural network, or a deep learning transformer.

9. The task modeling system of claim 1, wherein the plurality of processing clients comprises a first processing client and a second processing client, and wherein a number of processing cores of the first processing client is different from a number of processing cores of the second processing client.

10. The task modeling system of claim 1, wherein the plurality of processing clients comprises a first processing client and a second processing client, and wherein a power management factor implementable by a processing core of the first processing client is not implementable by a processing core of the second processing client.

11. The task modeling system of claim 1, wherein generating from the input data the assignment of processing tasks among the plurality of processing cores for completion within the predefined time duration comprises interpolating the assignment within the artificial neural network.

12. The task modeling system of claim 3, wherein a task modeler of the plurality of task modelers further comprises a data filtering criterion, and wherein the task modeler of the plurality of task modelers is configured to determine a subset of values from the aggregate task model using the data filtering criterion, and wherein the updating one or more parameters of its respective artificial neural network based on the aggregate task model comprises updating the one or more parameters based on the subset of values.

13. The task modeling system of claim 1, wherein the plurality of processing tasks are baseband processing tasks according to a Layer 1 or Layer 2 implementation of a 4G or 5G physical layer baseband processing.

14. The task modeling system of claim 2, wherein the artificial neural network comprises a plurality of weight parameters, and wherein receiving the task model data from each of the plurality of task modelers comprises receiving fewer than each weight parameter of each artificial neural network, and wherein the task model aggregator is configured to generate the aggregate task model based on the fewer than each weight parameter of each artificial neural network, wherein updating the one or more parameters of the respective artificial neural network based on the aggregate task model comprises updating the one or more parameters based on the aggregate task model based on the fewer than each weight parameter of each artificial neural network.

15. The task modeling system of claim 2, wherein the task model aggregator comprises a memory on which an aggregating artificial neural network is stored, and wherein generating the aggregate task model comprises the task model aggregator aggregating the task model data using the aggregating artificial neural network.

16. The task modeling system of claim 2, wherein
receiving task model data from each of the plurality of task modelers comprises
receiving learning rate and/or batch size.

17. The task modeling system of claim 2, wherein the task model aggregator is configured to generate a plurality of aggregate task models from the received plurality of task models; and
wherein the task model aggregator generates each aggregate task model according to a client factor, wherein the client factor comprises a processing client identity and/or one or more processing client preferences.

18. The task modeling system of claim 1, wherein the processing tasks comprise a first processing task and a second processing task, wherein the first processing task must be performed before the second processing task can be performed, and wherein determining from the input data the assignment of the processing tasks further comprises determining an order of the processing tasks wherein a core performs to first processing task before performing the second processing task.

19. A task model aggregator, comprising a processor, configured to:
receive task model data from each of a plurality of task modelers, wherein the task model data represent weights of an artificial neural network of each of the task modelers; and
generate an aggregate task model based on the received plurality of task models, according to an aggregation rule.

20. The task model aggregator of claim 19, wherein the task model data comprise weights of the artificial neural network of each task modeler, wherein the aggregation rule is an arithmetic mean, and wherein generating an aggregate task model based on the received plurality of task models comprises generating an aggregate task model weights as an average of the respective weights of the task model data of each of the plurality of processing clients.

21. The task model aggregator of claim 20, wherein the artificial neural network comprises a plurality of weight parameters, and wherein receiving the task model data from each of the plurality of task modelers comprises receiving each weight parameter of each artificial neural network.

22. The task model aggregator of claim 20, wherein the artificial neural network comprises a plurality of weight parameters, and wherein receiving the task model data from each of the plurality of task modelers comprises receiving fewer than each weight parameter of each artificial neural network, and wherein the task model aggregator is configured to generate the aggregate task model based on the fewer than each weight parameter of each artificial neural network.

23. The task model aggregator of claim 20, wherein the task model aggregator comprises a memory on which an aggregating artificial neural network is sorted, and wherein generating the aggregate task model comprises the task model aggregator aggregating the task model data using the aggregating artificial neural network.

24. The task model aggregator of claim 20, wherein
receiving task model data from each of the plurality of task modelers comprises
receiving learning rate and/or batch size.

25. The task model aggregator of claim 20, wherein the task model aggregator is configured to generate a plurality of aggregate task models from the received plurality of task models; and
wherein the task model aggregator generates each aggregate task model according to a client factor, wherein the client factor comprises a processing client identity and/or one or more processing client preferences.
